(19) United States
(12) Patent Application Publication
(10) Pub. No.: US 2013/0058285 A1
(43) Pub. Date: Mar. 7, 2013

(54) SPATIAL HASHING FOR ENHANCED CONTROL CHANNEL SEARCH SPACES

(71) Applicants: Tommi Koivisto, Espoo (FI); Timo Roman, Espoo (FI); Mihai Enescu, Espoo (FI)

(72) Inventors: Tommi Koivisto, Espoo (FI); Timo Roman, Espoo (FI); Mihai Enescu, Espoo (FI)

(73) Assignee: RENESAS MOBILE CORPORATION, Tokyo (JP)

(21) Appl. No.: 13/224,825

(22) Filed: Sep. 2, 2011

(51) Int. Cl. H04W 4/00

(52) U.S. Cl. 370/329

(57) ABSTRACT

The present invention provides a method, apparatus and a computer program product for spatial hashing for enhanced control channel search spaces. The present invention includes defining a control channel search space for searching for control channel candidates, defining search space locations within the search space, grouping the search space locations into a plurality of subsets of search space locations, associating each subset of search space locations with an antenna port, for each of a plurality of subframes, changing the search space locations from a first subset of search space locations to a second subset of search space locations.

### TECHNICAL FIELD

The present application relates generally to an apparatus and method and a computer program product for spatial hashing for enhanced control channel search spaces.

Currently, Release 10 of the 3^{rd} Generation Partnership Project (3GPP) Long Term Evolution (LTE) specification work starts to be in its final stages. It includes several new features related to downlink and uplink MIMO, relays, bandwidth extension via carrier aggregation and enhanced inter-cell interference coordination (eICIC).

In the meantime, 3GPP has also started working on the next release of the LTE specifications, i.e. Release 11. One ongoing Study Item there is downlink MIMO enhancements, one topic of which is downlink control signaling enhancements. Current downlink control signaling is based on common reference signals which are not precoded and are broadcast all over the cell. When multiple antennas are in use at an evolved NodeB (eNodeB), transmit diversity is applied, for example, space-frequency block coding (SFBC) in case of 2 Tx and space-frequency block coding frequency-switched transmit diversity (SFBC-FSTD) in case of 4 Tx). The mapping of the control channels to resource elements (REs) is fixed and based on cell ID. The current Study Item aims at enhancing downlink control channels, like the physical downlink control channel (PDCCH) or the physical hybrid-ARQ indicator channel (PHICH) in terms of capacity (spectral efficiency) by means of more advanced multi-antenna techniques, e.g. closed-loop single-user multiple input multiple output (SU-MIMO) or multi-user (MU-) MIMO or even Coordinated multi-point (COMP) transmission. At the same time another goal is to allow more flexibility in the mapping to resource elements in order to improve inter-cell interference coordination possibilities for control channels.

The present invention refers to control signaling enhancements for LTE.

### BACKGROUND

The following meanings for the abbreviations used in this specification apply:

3GPP The 3^{rd} Generation Partnership Project

BS Base Station

CCE Control Channel Element

CRS Common Reference Symbols

DCI Downlink Control Information

DM-RS Demodulation Reference Symbols

eNB evolved NodeB

FSTD Frequency-Switched Transmit Diversity

LTE Long Term Evolution

MIMO Multiple Input Multiple Output

MU-MIMO Multi-user MIMO

PDCCH Physical Downlink Control Channel

ePDCCH enhanced Physical Downlink Control Channel

PHICH Physical HARQ Indicator Channel

QPSK Quadrature Phase Shift Keying

RE Resource Element

RS Reference Signal

SFBC Space-Frequency Block Coding

UE User Equipment

The enhanced PDCCH (ePDCCH) is assumed in the description hereafter to be based on UE-specific (UE-RS) reference signals (RS), which can be also seen as ePDCCH specific RS in case each ePDCCH is transmitted using rank 1 transmission. These UE-specific RS can be in the form of currently existing Demodulation-RS (DM-RS), which have been specified during Release 9 and Release 10 or one may also envision a new type of UE-specific RS dedicated to ePDCCH demodulation with its own orthogonal port multiplexing scheme, RE mapping, sequence generation, etc.

Release 9/10 DM-RS have an overhead of 12 REs for ranks 1 and 2 and 24 REs for ranks 3-8. There are separate precoded UE-specific reference signals transmitted on each spatial layer, and UE demodulation is based on these reference signals as they allow the UE to estimate the precoded transmission channel.

Obviously, there needs to be some flexibility in the resource mapping for ePDCCH since ePDCCHs will be transmitted to multiple UEs in the same subframe (i.e. to provide multiple access capability). On the other hand, the UE has no prior knowledge of the resource mapping before starting to decode ePDCCH. At the same time, the ePDCCH may be link-adapted so the UE does not know the coding rate either. In Release 8 the used modulation is QPSK, however, also the modulation could become one additional unknown variable for ePDCCH as higher-order modulations may be considered in order to improve the spectral efficiency.

Finally, the used downlink control information (DCI) format is obviously unknown to the UE prior to decoding—in particular the length of the DCI format is needed for channel decoding.

Now with the enhanced PDCCH when multiple spatial layers are utilized, UE also will not know which spatial layer is assigned to, i.e. which UE-specific RS port is/are associated to its ePDCCH transmission. So, again one more unknown variable is brought into the decoding process.

Hence overall there are many unknown variables which the UE would need to know or hypothesize over for proper ePDCCH decoding.

In Release 8, the concept of blind decoding is utilized to overcome the above-mentioned issues. It literally means that the UE does several blind attempts to decode PDCCH with different assumptions about the coding rate, resource mapping and length of the DCI format. When the cyclic redundancy check (CRC) is successful, the UE can assume that it has successfully decoded PDCCH and that the corresponding hypotheses on the coding rate (i.e. number of CCEs), resource mapping and length of the DCI format (i.e. DCI format payload size) are then valid.

Obviously, such blind decoding needs to be limited somehow in order to avoid excessive UE decoding complexity and latency in decoding control information. Therefore, the concepts of control channel elements (CCEs), CCE aggregation tree and PDCCH search space have been introduced. The resource element space for PDCCHs has been divided into CCEs which in Release 8 consist of 36 resource elements each. PDCCH REs are first de-mapped at the UE in the form of a list of consecutive CCEs. UE attempts to decode a number of DCI formats of pre-defined sizes from either 1, 2, 4 or 8 aggregated CCEs. In other words when attempting to decode, UE is assuming that each DCI format of pre-defined size is mapped to {1,2,4,8}×36 resource elements, essentially implying the used coding rate.

This number of CCEs {1,2,4,8} is called aggregation level. For each aggregation level, there are multiple locations from which the UE searches for the DCI format within the list of received CCEs. The set of all locations that the UE will need to search through is called the PDCCH search space. The search space is divided into a common search space (typically used for system information scheduling) and a UE-specific search space (typically used for scheduling PDSCH or for UL grants).

FIG. 1 shows an illustration of the Release 8 PDCCH CCE aggregation tree and the hashing function changing the search space from subframe to subframe.

The structure of Rel-8 PDCCH is illustrated in the example of FIG. 1 where the full PDCCH resource space consists of altogether 16 CCEs. With 16 CCEs, at aggregation levels {1,2,4,8} there are {16,8,4,2} possible search space locations altogether respectively, organized in a tree structure as illustrated in the figure. The search space of a single UE obviously cannot span the full CCE space as this would mean prohibitively high number of blind decoding attempts for the UE.

Hence, the PDCCH search space for a given UE consists only of certain pre-defined starting locations at each aggregation level—in this example we have {3,3,1,1} locations on aggregation levels {1,2,4,8} respectively, i.e. the full search space size is then 8 locations from which the UE needs to search for the PDCCH.

From eNB perspective, the search space concept means that the eNB can only schedule PDCCH for the UE in these search space locations. In other words, the PDCCH scheduling is restricted. Hence, it is possible that there would be free resources in the overall PDCCH resource space but the UE cannot be scheduled since there are no free resources within the UE search space (for example, some other UE#2 has been scheduled to the PDCCH resources overlapping either partially or totally to the UE#1 search space). Such an event is called blocking, and obviously there is a desire to minimize the probability of blocking events. Especially difficult from blocking perspective are UEs scheduled on high aggregation levels. For example in the case of FIG. 1, another UE scheduled on aggregation level 8 on CCEs 0-7 in subframe n would block aggregation levels 1, 2 and 4 completely for the UE in the example.

In order to alleviate the blocking issue, the concept of hashing function was introduced in Release 8 for PDCCH. Essentially the hashing function changes the search space from subframe to subframe. This way it can be ensured that at least the same UEs are not blocking each other in the same subframe. Hashing is also illustrated in FIG. 1 where it is seen that the search space locations change from subframe n to subframe n+1. Among other inputs, the hashing function takes as input the UE ID and the slot number within the radio frame. This ensures that the search space is UE-specific and varies from one subframe to another.

As described in document [1], the set of PDCCH candidates to monitor are defined in terms of search spaces, where a search space Sₖ^{(L)} at aggregation level Lε{1,2,4,8} is defined by a set of PDCCH candidates. The CCEs corresponding to PDCCH candidate m of the search space Sₖ^{(L)} are given by

L·{(Yₖ+m)mod └N_{CCE,k}/L┘}+i

where Yₖ is defined below, i=0, . . . , L−1 and m=0, . . . , M^{(L)}−1. M^{(L)} is the number of PDCCH candidates to monitor in the given search space.

As defined in document [1], the UE shall monitor one common search space at each of the aggregation levels 4 and 8 and one UE-specific search space at each of the aggregation levels 1, 2, 4, 8. The common and UE-specific search spaces may overlap.

For the common search spaces, Yₖ is set to 0 for the two aggregation levels L=4 and L=8.

For the UE-specific search space Sₖ^{(L)} at aggregation level L, the variable Yₖ is defined by

Yₖ=(A·Yₖ₋₁)mod D

where Y₋₁=n_{RNTI}≠0, A=39827, D=65537 and k=└nₛ/2┘, nₛ is the slot number within a radio frame. The RNTI value used for n_{RNTI} is defined in document [1].

As mentioned above, with the enhanced PDCCH, the spatial domain with multiple spatial layers and associated UE-specific RS bring yet another dimension into the blind decoding process. On one hand the UE should not be required to estimate channels from an excessive number of different UE-specific RS ports, but also on the other hand the scheduling should not be restricted too much by fixing the UE-specific RS port for PDCCH demodulation as such restrictions are well-known to degrade MU-MIMO performance by restricting multi-user diversity because of restrictions in UE pairing, and furthermore the same blocking problem would arise again.

The problem addressed by the present invention is that of alleviating blocking and giving the eNB more scheduling freedom in scheduling PDCCHs when multiple spatial layers are utilized.

### PRIOR ART DOCUMENTS

[1] 3GPP, TS 36.213 V9.3.0 (September 2010); 3^{rd} Generation Partnership Project; Technical Specification Group Radio Access Network; Evolved Universal Terrestrial Radio Access (E-UTRA); Physical layer procedures (Release 9).

### SUMMARY OF THE INVENTION

It is an object of the present invention to provide an apparatus and method and a computer program product for spatial hashing for enhanced control channel search spaces.

According to an aspect of the present invention, there is provided a method, comprising:
defining a control channel search space for searching for control channel candidates,
defining search space locations within the search space,
grouping the search space locations into a plurality of subsets of search space locations,
associating each subset of search space locations with an antenna port,
for each of a plurality of subframes, changing the search space locations from a first subset of search space locations to a second subset of search space locations.

According to another aspect of the present invention, there is provided a method, comprising:
defining a control channel search space for searching for control channel candidates,
defining search space locations within the search space,
grouping the search space locations into N subsets of search space locations, wherein N is the number of antenna ports,
associating each of the N subsets of search space locations with one of the N antenna ports,
alternating the association between each of the N subsets and said antenna port for each of the N subframes,
changing the search space locations from a first subset of search space locations to a second subset of search space locations at every N subframe.

According to an aspect of the present invention, there is provided an apparatus, comprising:
at least one processor,
and at least one memory including computer program code,
the at least one memory and the computer program code configured to, with the at least one processor, cause the apparatus at least to perform:
defining a control channel search space for searching for control channel candidates,
defining search space locations within the search space,
grouping the search space locations into a plurality of subsets of search space locations,
associating each subset of search space locations with an antenna port,
for each of a plurality of subsets, changing the search space locations from a first subset of search space locations to a second subset of search space locations.

According to an aspect of the present invention, there is provided an apparatus, comprising:
at least one processor,
and at least one memory including computer program code,
the at least one memory and the computer program code configured to, with the at least one processor, cause the apparatus at least to perform:
defining a control channel search space for searching for control channel candidates,
defining search space locations within the search space,
grouping the search space locations into N subsets of search space locations, wherein N is the number of antenna ports,
associating each of the N subsets of search space locations with one of the N antenna ports,
alternating the association between each of the N subsets and said antenna port for each of the N subframes,
changing the search space locations from a first subset of search space locations of a second subset of search space locations at every N subframe.

According to an aspect of the present invention, there is provided method, comprising:
defining a control channel search space for scheduling control channel candidates,
defining search space locations within the search space,
scheduling one or a plurality of control channels in the defined search space locations, wherein
the search space locations are grouped into subsets,
each subset of search space locations is associated with an antenna port, and
for each of a plurality of subframes, the search space locations are changed from a first subset of search space locations to a second subset of search space locations.

According to an aspect of the present invention, there is provided method, comprising:
defining a control channel search space for scheduling control channel candidates,
defining search space locations within the search space,
scheduling one or a plurality of control channels in the defined search space locations, wherein
the search space locations are grouped into N subsets of search space locations, wherein N is the number of antenna ports,
each of the N subsets of search space locations is associated with one of the N antenna ports,
the association between each of the N subsets of search space locations and said antenna port for each of the N subframes is alternated,
the search space locations are changed from a first subset of search space locations to a second subset of search space locations at every N subframe.

According to an aspect of the present invention, there is provided an apparatus, comprising:
at least one processor,
and at least one memory including computer program code,
the at least one memory and the computer program code configured to, with the at least one processor, cause the apparatus at least to perform:
defining a control channel search space for scheduling control channel candidates,
defining search space locations within the search space,
scheduling one or a plurality of control channels in the defined search space locations, wherein
the search space locations are grouped into a plurality subsets,
each subset of search space locations is associated with an antenna port, and
for each of a plurality of subframes, the search space locations are changed from a first subset of search space locations to a second subset of search space locations.

According to an aspect of the present invention, there is provided an apparatus, comprising:
at least one processor,
and at least one memory including computer program code,
the at least one memory and the computer program code configured to, with the at least one processor, cause the apparatus at least to perform:
defining a control channel search space for scheduling control channel candidates,
defining search space locations within the search space,
scheduling one or a plurality of control channels in the defined search space locations, wherein
the search space locations are grouped into N subsets of search space locations, wherein N is the number of antenna ports,
each of the N subsets of search space locations is associated with one of the N antenna ports,
the association between each of the N subsets and said antenna port for each of the N subframes is alternated,
the search space locations are changed from a first subset of search space locations to a second subset of search space locations at every N subframe.

### BRIEF DESCRIPTION OF THE DRAWINGS

The above and other objects, features, details and advantages will become more fully apparent from the following detailed description of example embodiments which is to be taken in conjunction with the appended drawings, in which:

FIG. 1 shows an illustration of the Release 8-type of PDCCH CCE aggregation tree and the hashing function changing the search space from subframe to subframe.

FIG. 2 shows an example of a tree-structure based spatial hashing according to a first embodiment of the present invention.

FIG. 3 shows an illustration of space-time hashing according to a second embodiment of the present invention.

FIG. 4 shows an example of independent hashing for each RS port according to a third embodiment of the present invention.

FIG. 5 shows an example of independent hashing for each RS port with reduced search space according to a fourth embodiment of the present invention.

FIG. 6 shows a principle configuration of an example for an apparatus according to certain embodiments of the present invention.

FIG. 7 shows a principle flowchart of an example for a method according to certain embodiments of the present invention.

FIG. 8 shows a principle flowchart of another example for a method according to certain embodiments of the present invention.

FIG. 9 shows a principle configuration of an example for another apparatus according to certain embodiments of the present invention.

FIG. 10 shows a principle flowchart of an example for another method according to certain embodiments of the present invention.

FIG. 11 shows a principle flowchart of another example for another method according to certain embodiments of the present invention.

### DETAILED DESCRIPTION

In the following, embodiments of the present invention are described by referring to general and specific examples of the embodiments. It is to be understood, however, that the description is given by way of example only, and that the described embodiments are by no means to be understood as limiting the present invention thereto.

According to an aspect of the present invention, a spatial component is added to the PDCCH hashing function. Essentially this provides randomization of the PDCCH search space in spatial domain, and hence reduces blocking since it becomes unlikely that UEs that are spatially compatible (such that they can be paired in multi-user MIMO sense) would be allocated the same UE-specific RS port (and scrambling ID) in consecutive subframes. Hence the PDCCH scheduling with MU-MIMO will not be blocked in all subframes due to RS allocation. In other words, the spatial domain offers another dimension for ePDCCH multiplexing which allows increasing its capacity and reducing blocking.

Hence the dedicated RS port that UE will be searching through in the PDCCH blind decoding process will depend on the CCE and subframe numbers.

As described above, the blind decoding process amounts to decoding control channel candidates under certain hypotheses on the coding rate, resource mapping, length of the DCI format, and, according to the present invention, the UE-specific antenna port. When the cyclic redundancy check (CRC) is successful, the UE can assume that it has successfully decoded PDCCH and that the corresponding hypotheses are valid.

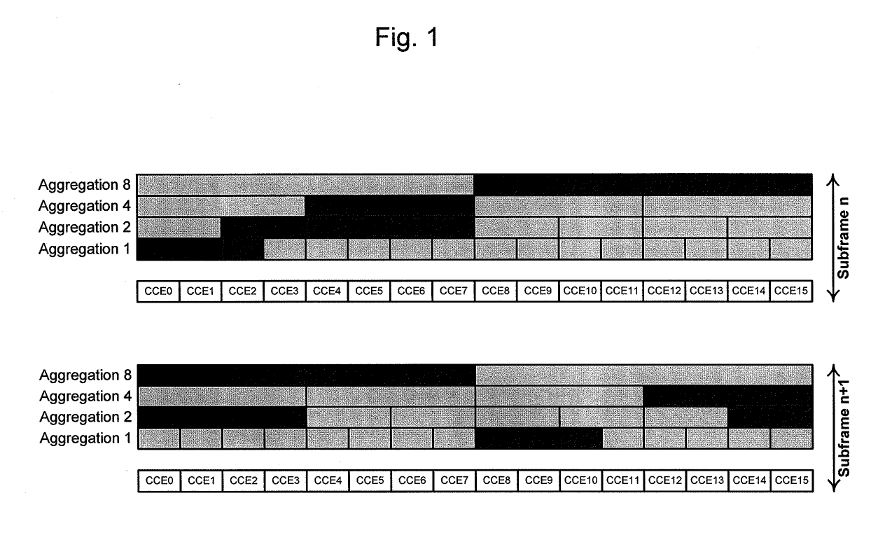

In the following, there are described four possible ways of implementing a spatial hashing function for ePDCCH. Baseline is the example of FIG. 1 which illustrates the principle of the usual single RS port hashing function, as described above.

### Embodiment 1

### Tree Structure-Based Spatial Hashing

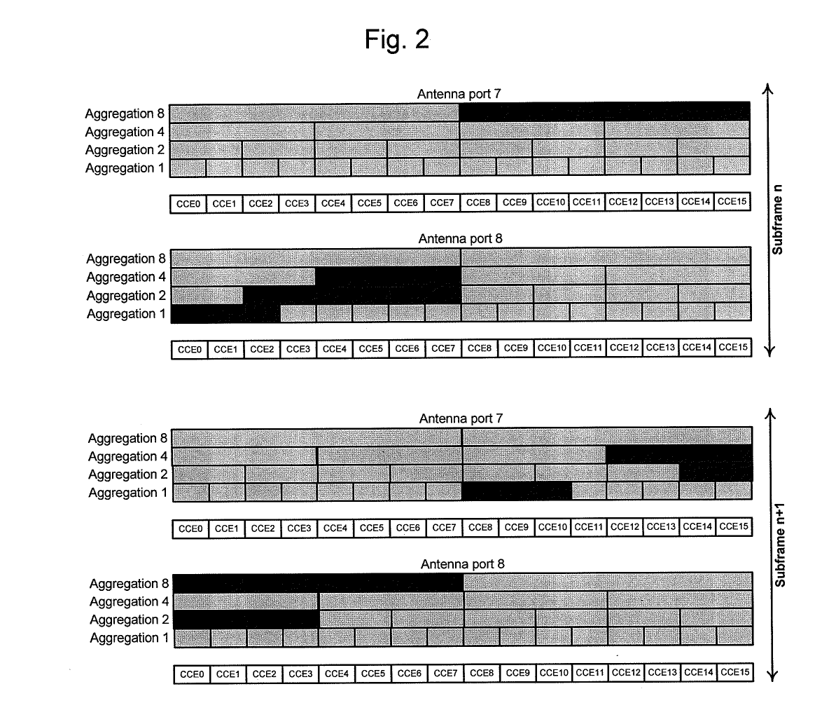

In the first embodiment, the spatial hashing is done such that for each CCE the UE only needs to estimate channels from one DM-RS port. This is achieved such that the search space locations corresponding to each DM-RS port are fully non-overlapping. As an example, expanding the example of FIG. 1 to multiple DM-RS ports, one might assign separate parts of the overall CCE space to different DM-RS ports to achieve this. In the example of FIG. 2, the CCEs in the second half are decoded based on antenna port 7 and CCEs in the first half of the overall CCE space are decoded based on antenna port 8. The benefit of the method is obviously reduced channel estimation complexity while both ports 7 and 8 are enabled at least in some part of the search space allowing flexibility for scheduling ePDCCH in MU-MIMO over orthogonal DM-RS ports.

### Embodiment 2

### Space-Time Hashing Function

In the second embodiment, instead of having the search space locations changed in every subframe, as described in the first embodiment, the overall search space locations are changed only every N subframes in case N DM-RS ports are in use. Then, within the N subframes, the search space locations are alternated between the N DM-RS ports. The overall search space is split into N subsets, and in each of the N subframes each DM-RS port is associated with a different subset of the search space locations. It is noted that the subsets are fully non-overlapping (or disjoint), as described above. However, alternatively, it is also possible that the subsets are partially overlapping (or not disjoint).

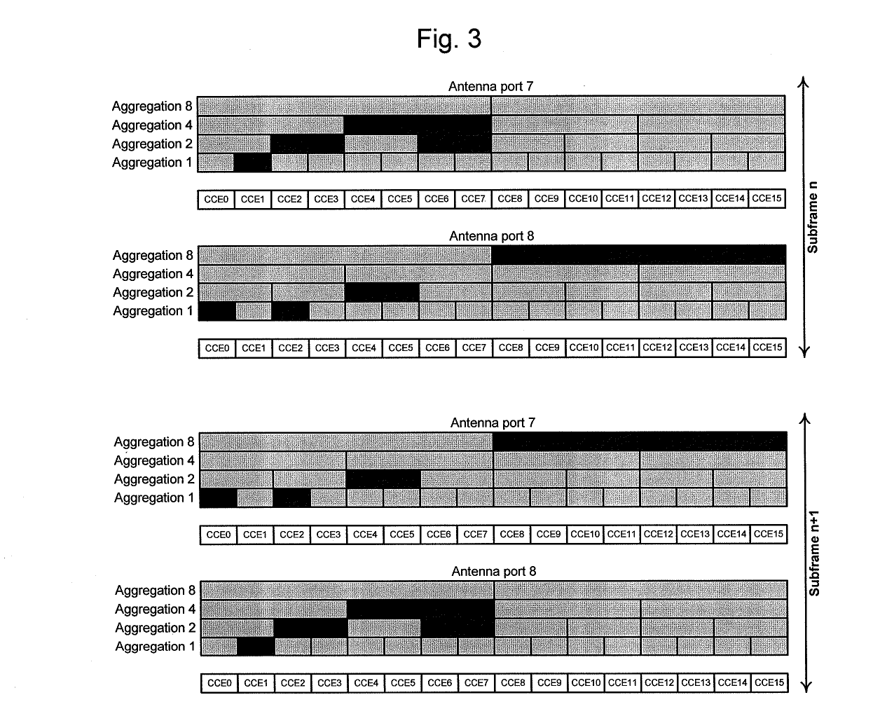

FIG. 3 illustrates the idea with N=2. Hence, the full search space is divided into two subsets. In subframe n, antenna port 7 is associated with the first subset and antenna port 8 with the second subset, and in subframe n+1 the association is vice versa.

### Embodiment 3

### Independent Hashing for Each DM-RS Port

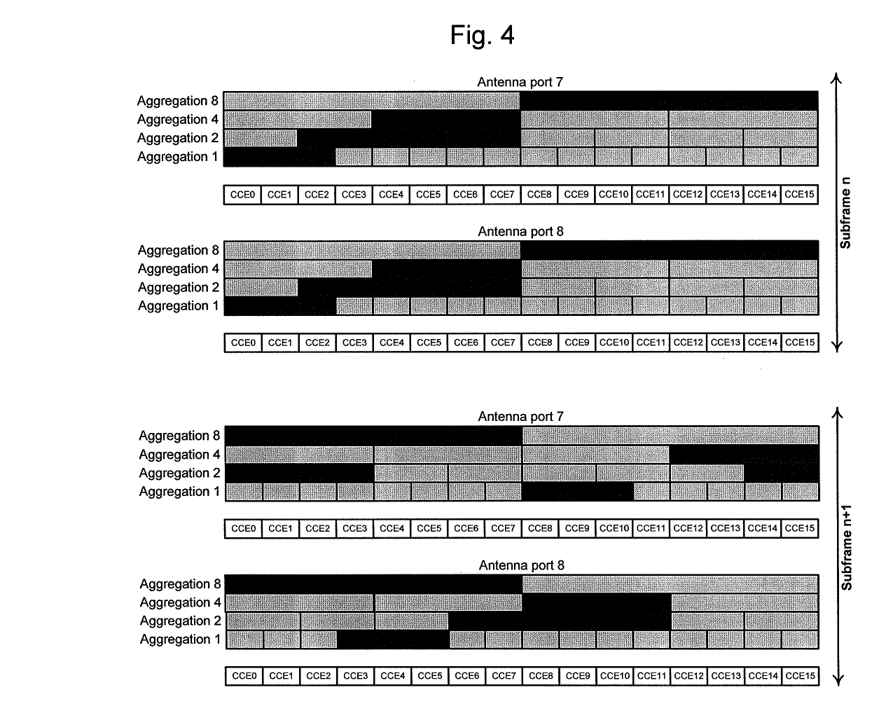

In the third embodiment of the present invention, there are separate search spaces defined for all DM-RS ports, and hashing is DM-RS port-specific. This results in completely independent search spaces associated with each DM-RS port, which is illustrated in FIG. 4.

### Embodiment 4

### Independent Hashing Combined with Reduced Search Space Per DM-RS Port

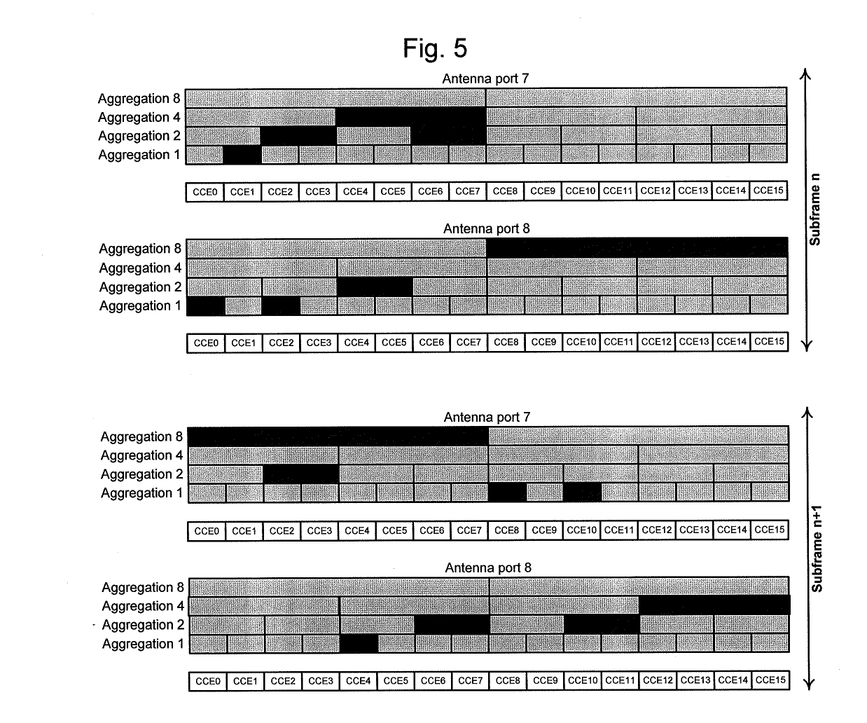

Finally, according to a fourth embodiment of the present invention, to avoid excessive amount of blind decodings to be performed by the UE, a simplification of the method as described in the third embodiment is considered to reduce the search space size associated with each DM-RS port. This can be done such that the overall search space size still remains the same compared to the baseline case, e.g. in the embodiment shown in FIG. 5 the overall search space sizes on aggregation levels {1,2,4,8} are still {3,3,1,1}, respectively.

According to such an approach, the amount of blind decodings at the UE is kept under control.

In the above description, different embodiments of the invention have been mentioned.

However, it is noted that the aspect of certain embodiments of the invention is to define a spatial hashing function that randomizes the search space also across DM-RS ports.

The above described embodiments explain specific examples of how to do it and one could probably envision other kinds of methods, for example any suitable combination of the above four embodiments.

In the above described embodiments, a total number of two DM-RS ports is assumed, but the principles described in this invention report extend to any number of DM-RS ports.

Further, while for convenience of explanation, the Release 9/10 DM-RS terminology has been used, it is acknowledged that other type of reference symbols are suitable to this process, like e.g. reference symbols that may be UE specific precoded or beam specific precoded.

As to the related UE and eNB procedures according to the present invention, it is noted that the hashing function has to be written in the specification such that both the eNB and the UE have in each subframe a common understanding about the search space associated with each DM-RS port.

For example, when scheduling the ePDCCH, the eNB selects a suitable search space location where to schedule the ePDCCH for the UE. This involves at least:
Selecting the aggregation level (coding rate) based on e.g. CQI knowledge from the UE.
Checking whether the UE can be paired in MU-MIMO with another UE, and determining which DM-RS ports should be used for both UEs.
Finding a suitable search space location given the aggregation level and the DM-RS port. If there is no such location, the eNB for example tries pairing with other UEs, or uses single-user transmission instead. In fact the three steps listed here may need to be iterated multiple times to find the suitable search space location.

Further, when receiving ePDCCH, the UE attempts to decode ePDCCH from each search space location.
The specified hashing function gives the information about which search space locations the UE will need to try with each DM-RS port for channel estimation for ePDCCH demodulation in a given subframe.
ePDCCH is detected when the CRC matches correctly.

According to certain embodiments of the present invention, there are enabled better possibilities for the eNB to perform MU-MIMO on the enhanced PDCCH, since DM-RS port allocation is made more dynamic. At the same time blocking probability is kept low.

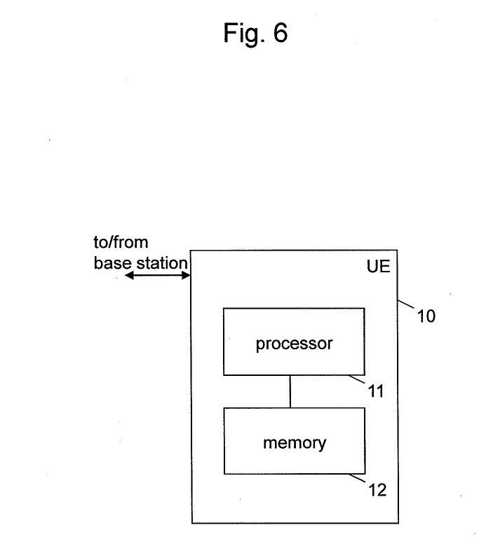

FIG. 6 shows a principle configuration of an example for an apparatus according to certain embodiments of the present invention. One option for implementing this example for an apparatus according to certain embodiments of the present invention would be a component in a handset such as user equipment UE according to LTE.

Specifically, as shown in FIG. 6, the example for an apparatus 10 comprises at least one processor 11, and at least one memory 12 including computer program code, the at least one memory and the computer program code configured to, with the at least one processor, cause the apparatus at least to perform defining a control channel search space for searching for control channel candidates, defining search space locations within the search space, grouping the search space locations into a plurality of subsets of search space locations, associating each subset of search space locations with an antenna port, for each of a plurality of subframes, changing the search space locations from a first subset of search space locations to a second subset of search space locations.

According to another embodiment, the at least one memory and the computer program code are further configured to, with the at least one processor, cause the apparatus to perform defining a control channel search space for searching for control channel candidates, defining search space locations within the search space, grouping the search space locations into N subsets of search space locations, wherein N is the number of antenna ports, associating each of the N subsets of search space locations with one of the N antenna ports, alternating the association between each of the N subsets and said antenna port for each of the N subframes, changing the search space locations from a first subset of search space locations to a second subset of search space locations at every N subframe.

In the foregoing exemplary description of the apparatus, only the units that are relevant for understanding the principles of the invention have been described using functional blocks. The apparatus may comprise further units that are necessary for its respective operation. However, a description of these units is omitted in this specification. The arrangement of the functional blocks of the devices is not construed to limit the invention, and the functions may be performed by one block or further split into sub-blocks.

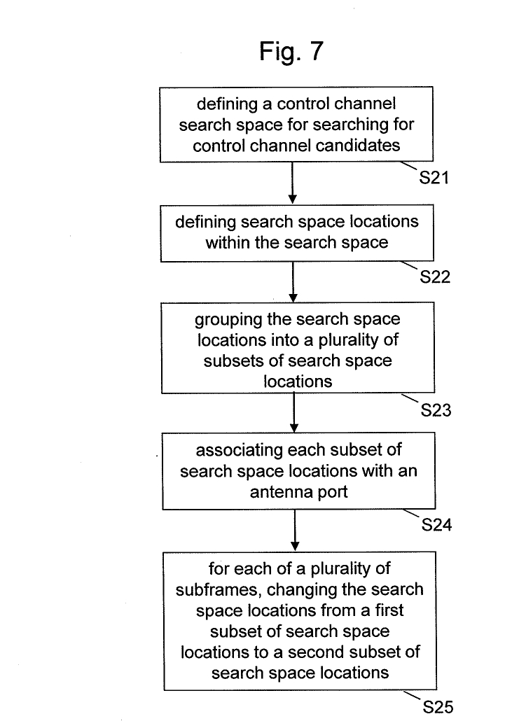

FIG. 7 shows a principle flowchart of an example for a method according to certain embodiments of the present invention. That is, as shown in FIG. 7, this method comprises defining, at step S21, a control channel search space for searching for control channel candidates, defining, at step S22, search space locations within the search space, grouping, at step S23, the search space locations into a plurality of subsets of search space locations, associating, at step S24, each subset of search space locations with an antenna port, and for each of a plurality of subframes, changing, at step S25, the search space locations from a first subset of search space locations to a second subset of search space locations.

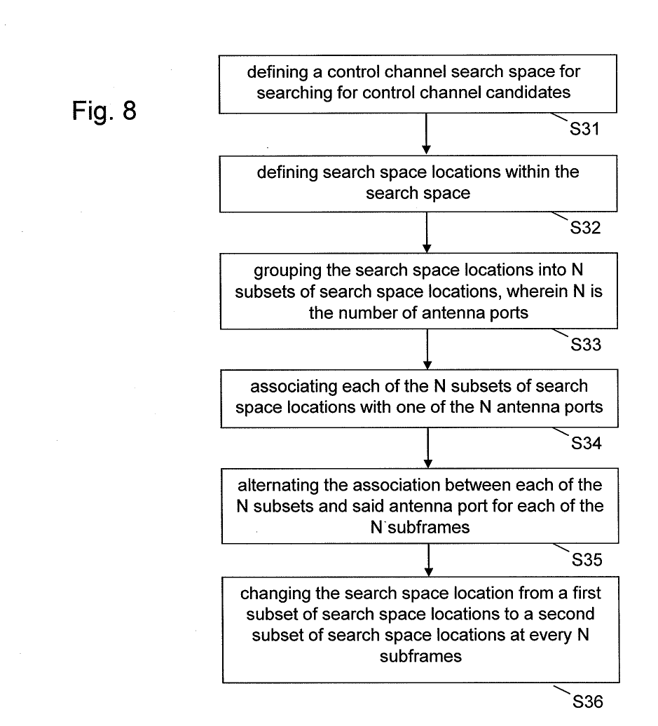

FIG. 8 shows a principle flowchart of another example for a method according to certain embodiments of the present invention. That is, as shown in FIG. 8, this method comprises defining, at step S31, a control channel search space for searching for control channel candidates, defining, at step S32, search space locations within the search space, grouping, at step S33, the search space locations into N subsets of search space locations, wherein N is the number of antenna ports, associating, at step S34, each of the N subsets of search space locations with one of the N antenna ports, alternating, at step S35, the association between each of the N subsets and said antenna port for each of the N subframes, and changing, at step S36, the search space location from a first subset of search space locations to a second subset of search space locations at every N subframes.

One option for performing the example of a method according to certain embodiments of the present invention would be to use the apparatus as described above or a modification thereof which becomes apparent from the embodiments as described above.

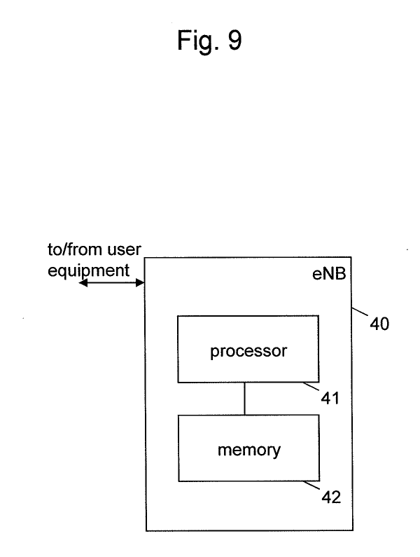

FIG. 9 shows another principle configuration of an example for an apparatus according to certain embodiments of the present invention. One option for implementing this example for an apparatus according to certain embodiments of the present invention would be a component in a base station such as an eNB according to LTE.

Specifically, as shown in FIG. 9, the example for an apparatus 40 comprises at least one processor 41, and at least one memory 42 including computer program code, the at least one memory and the computer program code configured to, with the at least one processor, cause the apparatus at least to perform defining a control channel search space for scheduling control channels, defining search space locations within the search space, scheduling one or a plurality of control channels in the defined search space locations, wherein the search space locations are grouped into a plurality subsets, each subset of search space locations is associated with an antenna port, and for each of a plurality of subframes, the search space locations are changed from a first subset of search space locations to a second subset of search space locations.

According to another embodiment, the at least one memory and the computer program code are further configured to, with the at least one processor, cause the apparatus to defining a control channel search space for scheduling control channels, defining search space locations within the search space, scheduling one or a plurality of control channels in the defined search space locations, wherein the search space locations are grouped into N subsets of search space locations, wherein N is the number of antenna ports, each of the N subsets of search space locations is associated with one of the N antenna ports, the association between each of the N subsets and said antenna port for each of the N subframes is alternated, the search space locations are changed from a first subset of search space locations to a second subset of search space locations at every N subframe.

In the foregoing exemplary description of the apparatus, only the units that are relevant for understanding the principles of the invention have been described using functional blocks. The apparatus may comprise further units that are necessary for its respective operation. However, a description of these units is omitted in this specification. The arrangement of the functional blocks of the devices is not construed to limit the invention, and the functions may be performed by one block or further split into sub-blocks.

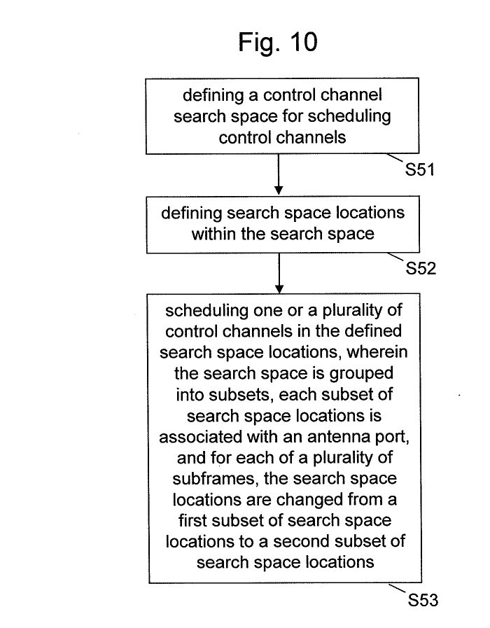

FIG. 10 shows a principle flowchart of an example for a method according to certain embodiments of the present invention. That is, as shown in FIG. 10, this method comprises defining, at step S51, a control channel search space for scheduling control channels, defining, at step S52, search space locations within the search space, and scheduling, at step S53, one or a plurality of control channels in the defined search space locations, wherein the search space is grouped into subsets, each subset of search space locations is associated with an antenna port, and for each of a plurality of subframes, the search space locations are changed from a first subset of search space locations to a second subset of search space locations.

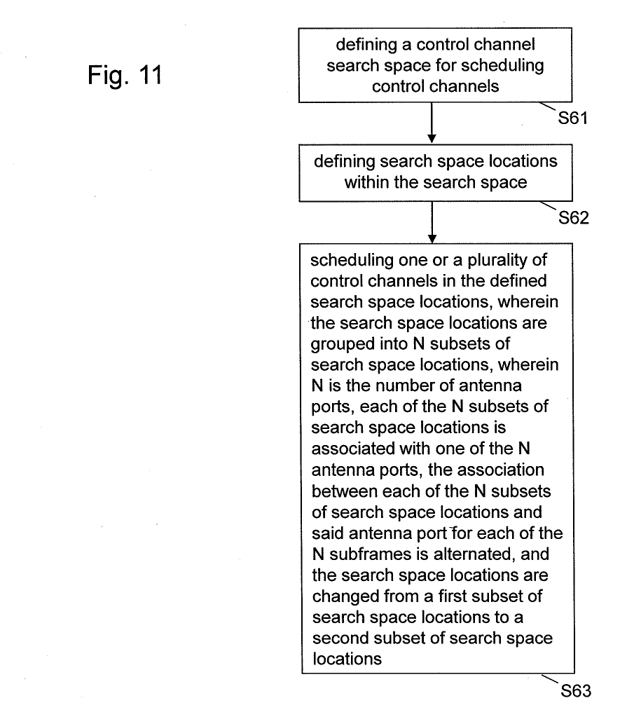

FIG. 11 shows a principle flowchart of another example for a method according to certain embodiments of the present invention. That is, as shown in FIG. 11, this method comprises defining, at step S61, a control channel search space for scheduling control channels, defining, at step S62, search space locations within the search space, and scheduling, at step S63, one or a plurality of control channels in the defined search space locations, wherein the search space locations are grouped into N subsets of search space locations, wherein N is the number of antenna ports, each of the N subsets of search space locations is associated with one of the N antenna ports, the association between each of the N subsets of search space locations and said antenna port for each of the N subframes is alternated, and the search space locations are changed from a first subset of search space locations to a second subset of search space locations.

One option for performing the example of a method according to certain embodiments of the present invention would be to use the apparatus as described above or a modification thereof which becomes apparent from the embodiments as described above.

It is noted that in each of the above described embodiment, the search space locations corresponding to each antenna port are partially overlapping or fully non-overlapping.

For the purpose of the present invention as described herein above, it should be noted that
method steps likely to be implemented as software code portions and being run using a processor at a user equipment (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses and user equipments, or any one of their respective units/means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

It is noted that the embodiments and general and specific examples described above are provided for illustrative purposes only and are in no way intended that the present invention is restricted thereto. Rather, it is the intention that all variations and modifications which fall within the scope of the appended claims are covered.

1. A method, comprising:
defining a control channel search space for searching for control channel candidates,
defining search space locations within the search space,
grouping the search space locations into a plurality of subsets of search space locations,
associating each subset of search space locations with an antenna port,
for each of a plurality of subframes, changing the search space locations from a first subset of search space locations to a second subset of search space locations.

2. The method according to claim 1, further comprising
decoding the control channel candidates from the defined search space locations.

3. The method according to claim 1, wherein the subsets of search space locations corresponding to each antenna port are partially overlapping or fully non-overlapping.

4. The method according to claim 1, further comprising:
defining separate search space locations within the search space for each antenna port,
changing the subset of search space locations for one antenna port independently of the subset of search space locations for another antenna port.

5. The method according to claim 4, further comprising:
reducing the number of search space locations in a subset for each antenna port.

6. A method, comprising:
defining a control channel search space for searching for control channel candidates,
defining search space locations within the search space,
grouping the search space locations into N subsets of search space locations, wherein N is the number of antenna ports,
associating each of the N subsets of search space locations with one of the N antenna ports,
alternating the association between each of the N subsets and said antenna port for each of the N subframes,
changing the search space locations from a first subset of search space locations to a second subset of search space locations at every N subframe.

7. The method according to claim 6, wherein the subsets of search space locations corresponding to each antenna port are partially overlapping or fully non-overlapping.

8. The method according to claim 6, further comprising
decoding the control channel candidates from the defined search space locations.

9. An apparatus, comprising:
at least one processor,
and at least one memory including computer program code,
the at least one memory and the computer program code configured to, with the at least one processor, cause the apparatus at least to perform:
defining a control channel search space for searching for control channel candidates,
defining search space locations within the search space,
grouping the search space locations into a plurality of subsets of search space locations,
associating each subset of search space locations with an antenna port,
for each of a plurality of subsets, changing the search space locations from a first subset of search space locations to a second subset of search space locations.

10. The apparatus according to claim 9, wherein the search space locations corresponding to each antenna port are partially overlapping or fully non-overlapping.

11. The apparatus according to claim 9, wherein the at least one memory and the computer program code is further configured to, with the at least one processor, cause the apparatus at least to perform:
defining separate search space locations within the search space for each antenna port,
changing the subset of search space locations for one antenna port independently of the subset of search space locations for another antenna port.

12. The apparatus according to claim 11, wherein the at least one memory and the computer program code is further configured to, with the at least one processor, cause the apparatus at least to perform:
reducing the number of search space locations in a subset for each antenna port.

13. The apparatus according to claim 9, wherein the at least one memory and the computer program code is further configured to, with the at least one processor, cause the apparatus at least to perform:
decoding the control channel candidates from the defined search space locations.

14. An apparatus, comprising:
at least one processor,
and at least one memory including computer program code,
the at least one memory and the computer program code configured to, with the at least one processor, cause the apparatus at least to perform:
defining a control channel search space for searching for control channel candidates,
defining search space locations within the search space,
grouping the search space locations into N subsets of search space locations, wherein N is the number of antenna ports,
associating each of the N subsets of search space locations with one of the N antenna ports,
alternating the association between each of the N subsets and said antenna port for each of the N subframes,
changing the search space locations from a first subset of search space locations to a second subset of search space locations at every N subframe.

15. The apparatus according to claim 14, wherein the subsets of search space locations corresponding to each antenna port are partially overlapping or fully non-overlapping.

16. The apparatus according to claim 14, wherein the at least one memory and the computer program code is further configured to, with the at least one processor, cause the apparatus at least to perform:
decoding the control channel candidates from the defined search space locations.

17. A method comprising:
defining a control channel search space for scheduling control channels,
defining search space locations within the search space,
scheduling one or a plurality of control channels in the defined search space locations, wherein
the search space locations are grouped into subsets,
each subset of search space locations is associated with an antenna port, and
for each of a plurality of subframes, the search space locations are changed from a first subset of search space locations to a second subset of search space locations.

18. The method according to claim 17, wherein the search space locations corresponding to each antenna port are partially overlapping or fully non-overlapping.

19. The method according to claim 17, further comprising:
defining separate search space locations within the search space for each antenna port,
changing the subset of search space locations for one antenna port independently of the subset of search space locations for another antenna port.

20. The method according to claim 19, further comprising:
reducing the number of search space locations in a subset for each antenna port.

21. A method, comprising:
defining a control channel search space for scheduling control channels,
defining search space locations within the search space,
scheduling one or a plurality of control channels in the defined search space locations, wherein
the search space locations are grouped into N subsets of search space locations, wherein N is the number of antenna ports,
each of the N subsets of search space locations is associated with one of the N antenna ports,
the association between each of the N subsets of search space locations and said antenna port for each of the N subframes is alternated,
the search space locations are changed from a first subset of search space locations to a second subset of search space locations at every N subframe.

22. The method according to claim 21, wherein the subsets of search space locations corresponding to each antenna port are partially overlapping or fully non-overlapping.

23. An apparatus, comprising:
at least one processor,
and at least one memory including computer program code,
the at least one memory and the computer program code configured to, with the at least one processor, cause the apparatus at least to perform:
defining a control channel search space for scheduling control channels,
defining search space locations within the search space,
scheduling one or a plurality of control channels in the defined search space locations, wherein
the search space locations are grouped into a plurality subsets,
each subset of search space locations is associated with an antenna port, and
for each of a plurality of subframes, the search space locations are changed from a first subset of search space locations to a second subset of search space locations.

24. The apparatus according to claim 23, wherein the subsets of search space locations corresponding to each antenna port are partially overlapping or fully non-overlapping.

25. The apparatus according to claim 23, wherein the at least one memory and the computer program code is further configured to, with the at least one processor, cause the apparatus at least to perform:
defining separate search space locations within the search space for each antenna port,
changing the subset of search space locations for one antenna port independently of the subset of search space locations for another antenna port.

26. The apparatus according to claim 25, wherein the at least one memory and the computer program code is further configured to, with the at least one processor, cause the apparatus at least to perform:
reducing the number of search space locations in a subset for each antenna port.

27. An apparatus, comprising:
at least one processor,
and at least one memory including computer program code,
the at least one memory and the computer program code configured to, with the at least one processor, cause the apparatus at least to perform:
defining a control channel search space for scheduling control channels,
defining search space locations within the search space,
scheduling one or a plurality of control channels in the defined search space locations, wherein
the search space locations are grouped into N subsets of search space locations, wherein N is the number of antenna ports,
each of the N subsets of search space locations is associated with one of the N antenna ports,
the association between each of the N subsets and said antenna port for each of the N subframes is alternated,
the search space locations are changed from a first subset of search space locations to a second subset of search space locations at every N subframe.

28. The apparatus according to claim 27, wherein the subsets of search space locations corresponding to each antenna port are partially overlapping or fully non-overlapping.
